(19) United States
(12) Patent Application Publication
(10) Pub. No.: US 2025/0016797 A1
(43) Pub. Date: Jan. 9, 2025

(54) METHOD AND DEVICE FOR CONFIGURING REFERENCE SIGNAL FOR COVERAGE EXTENSION

(71) Applicant: Electronics and Telecommunications Research Institute, Daejeon (KR)

(72) Inventors: Cheul Soon KIM, Daejeon (KR); Sung Hyun MOON, Daejeon (KR); Jung Hoon LEE, Daejeon (KR)

(21) Appl. No.: 18/710,166

(22) PCT Filed: Nov. 15, 2022
(86) PCT No.: PCT/KR2022/017981

§ 371 Date: May 14, 2024

(30) Foreign Application Priority Data
Nov. 17, 2021 (KR) 10-2021-0158710
Sep. 20, 2022 (KR) 10-2022-0118909

(51) Int. Cl. H04W 72/232; H04L 5/00

(52) U.S. Cl. CPC H04W 72/232; H04L 5/0048

(57) ABSTRACT

A method and a device for configuring a reference signal for coverage extension are disclosed. A method of a terminal comprises the steps of: receiving, from a base station, DCI including information indicating whether PT-RS is mapped; identifying that the PT-RS is mapped to a data channel on the basis of the information; and performing a procedure of transmitting or receiving the data channel including the PT-RS to or from the base station.

### TECHNICAL FIELD

The present disclosure relates to a communication technique, and more particularly, to a technique for configuring a reference signal for coverage extension.

### BACKGROUND ART

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

The 5G communication system (e.g., communication system supporting the NR) using a higher frequency band (e.g., frequency band of 6 GHz or above) than a frequency band (e.g., frequency band of 6 GHz or below) of the 4G communication system is being considered for processing of wireless data soaring after commercialization of the 4G communication system (e.g., communication system supporting the LTE). The 5G communication system can support enhanced mobile broadband (eMBB), ultra-reliable low-latency communication (URLLC), massive machine type communication (mMTC), and the like. Discussion on a sixth generation (6G) communication system after the 5G communication system is in progress.

Meanwhile, a new reference signal may be introduced for signal coverage extension. The new reference signal may be used for phase noise estimation/compensation. The new reference signal may be used in uplink communication and/or downlink communication, and in this case, methods for configuring the new reference signal are required.

### DISCLOSURE

### Technical Problem

The present disclosure is directed to providing a method and an apparatus for configuring a reference signal for coverage extension.

### Technical Solution

A method of a terminal, according to a first exemplary embodiment of the present disclosure for achieving the above-described objective, may comprise: receiving, from a base station, downlink control information (DCI) including information indicating whether a phase tracking-reference signal (PT-RS) is mapped; identifying that the PT-RS is mapped on a data channel based on the information; and performing a transmission/reception procedure of the data channel including the PT-RS with the base station.

The data channel may be a physical downlink shared channel (PDSCH) including system information or a paging message, and the DCI may schedule the PDSCH.

The data channel may be a physical uplink shared channel (PUSCH) transmitted in a random access procedure, and the DCI may schedule the PUSCH.

The method may further comprise receiving information indicating a mapping interval of the PT-RS from the base station, wherein the PT-RS may be mapped in time domain according to the mapping interval indicated by the base station.

The PT-RS may be mapped according to the mapping interval based on a demodulation (DM)-RS of the data channel.

The method may further comprise transmitting uplink control information (UCI) to the base station on a physical uplink control channel (PUCCH), wherein the PT-RS may be mapped on the PUCCH.

The PT-RS may be mapped before a DM-RS symbol on the PUCCH.

A method of a base station, according to a second exemplary embodiment of the present disclosure for achieving the above-described objective, may comprise: transmitting, to a terminal, downlink control information (DCI) including information indicating whether a phase tracking-reference signal (PT-RS) is mapped; and in response to that the PT-RS is indicated to be mapped on a data channel, performing a transmission/reception procedure of the data channel including the PT-RS with the terminal.

The data channel may be a physical downlink shared channel (PDSCH) including system information or a paging message, and the DCI may schedule the PDSCH.

The data channel may be a physical uplink shared channel (PUSCH) transmitted in a random access procedure, and the DCI may schedule the PUSCH.

The method may further comprise transmitting information indicating a mapping interval of the PT-RS to the terminal, wherein the PT-RS may be mapped in time domain according to the mapping interval.

The PT-RS may be mapped according to the mapping interval based on a demodulation (DM)-RS of the data channel.

The method may further comprise receiving uplink control information (UCI) from the terminal on a physical uplink control channel (PUCCH), wherein the PT-RS may be mapped on the PUCCH.

The PT-RS may be mapped before a DM-RS symbol on the PUCCH.

A terminal, according to a third exemplary embodiment of the present disclosure for achieving the above-described objective, may comprise a processor, and the processor may cause the terminal to perform: receiving, from a base station, downlink control information (DCI) including information indicating whether a phase tracking-reference signal (PT-RS) is mapped; identifying that the PT-RS is mapped on a data channel based on the information; and performing a transmission/reception procedure of the data channel including the PT-RS with the base station.

The data channel may be a physical downlink shared channel (PDSCH) including system information or a paging message, and the DCI may schedule the PDSCH.

The data channel may be a physical uplink shared channel (PUSCH) transmitted in a random access procedure, and the DCI may schedule the PUSCH.

The processor may further cause the terminal to perform: receiving information indicating a mapping interval of the PT-RS from the base station, wherein the PT-RS may be mapped in time domain according to the mapping interval indicated by the base station.

The PT-RS may be mapped according to the mapping interval based on a demodulation (DM)-RS of the data channel.

The processor may further cause the terminal to perform: transmitting uplink control information (UCI) to the base station on a physical uplink control channel (PUCCH), wherein the PT-RS may be mapped before a DM-RS symbol on the PUCCH.

### Advantageous Effects

According to the present disclosure, in uplink communication, a phase tracking-reference signal (PT-RS) may be mapped on a physical uplink control channel (PUCCH) and/or a physical shared channel (PUSCH). In downlink communication, a PT-RS may be mapped on a physical downlink shared channel (PDSCH). Based on the PT-RS, a phase noise for signals may be estimated, and the estimated phase noise may be compensated for. Accordingly, a coverage of the signals can be extended, and performance of the communication system can be improved.

### DESCRIPTION OF DRAWINGS

FIG. 1 is a conceptual diagram illustrating a first exemplary embodiment of a communication system,

FIG. 2 is a block diagram illustrating a first exemplary embodiment of a communication node constituting a communication system.

FIG. 3 is a conceptual diagram illustrating a first exemplary embodiment of a change in a transmission power according to simultaneous transmissions of a terminal in time/frequency resources.

FIG. 4 is a conceptual diagram illustrating a first exemplary embodiment of a method for simultaneous transmission of PUSCHs in two serving cells.

FIG. 5 is a conceptual diagram illustrating a second exemplary embodiment of a method for simultaneous transmission of PUSCHs in two serving cells.

FIG. 6 is a conceptual diagram illustrating a first exemplary embodiment of a method of estimating a phase noise using a PT-RS at a boundary of a UL coherence window.

FIG. 7A is a conceptual diagram illustrating a first exemplary embodiment of a method for PUCCH DM-RS and PT-RS configuration.

FIG. 7B is a conceptual diagram illustrating a second exemplary embodiment of a method for PUCCH DM-RS and PT-RS configuration.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. ‘Configuration of information element(s) (e.g., parameter(s))’ may mean that the corresponding information element(s) are signaled. The signaling may be at least one of system information (SI) signaling (e.g., transmission of system information block (SIB) and/or master information block (MIB)), RRC signaling (e.g., transmission of RRC message(s), RRC parameter(s) and/or higher layer parameter(s)), MAC control element (CE) signaling (e.g., transmission of a MAC message and/or MAC CE), PHY signaling (e.g., transmission of downlink control information (DCI), uplink control information (UCI), and/or sidelink control information (SCI)), or a combination thereof.

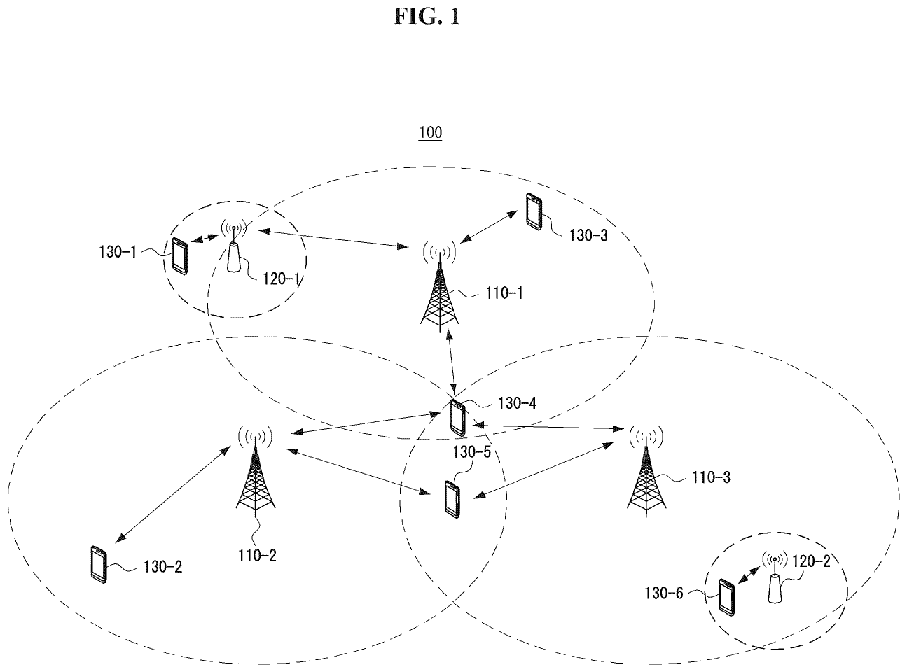

FIG. 1 is a conceptual diagram illustrating a first exemplary embodiment of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g., serving-gateway (S-GW), packet data network (PDN)-gateway (P-GW), and mobility management entity (MME)). When the communication system 100 is the 5G communication system (e.g., NR system), the core network may include an access and mobility management function (AMF), a user plane function (UPF), a session management function (SMF), and the like.

The plurality of communication nodes 110 to 130 may support the communication protocols (e.g., LTE communication protocol, LTE-A communication protocol, NR communication protocol, etc.) defined by technical specifications of 3rd generation partnership project (3GPP). The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like. Each of the plurality of communication nodes may have the following structure.

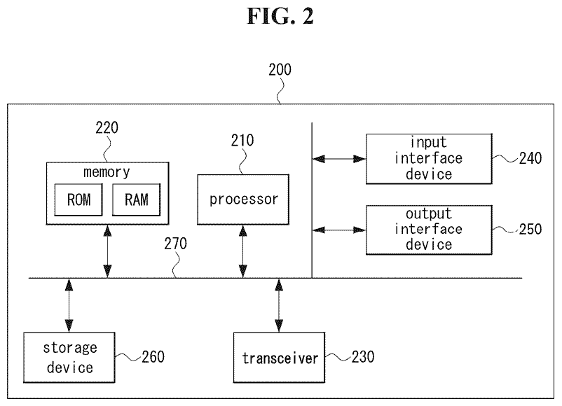

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), an advanced base station (BTS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station.

Scenarios to which communication is applied may be an Enhanced Mobile BroadBand (eMBB) scenario, a Massive Machine-Type Communication (mMTC) scenario, an Ultra-Reliable and Low-Latency Communication (URLLC) scenario, and/or Time Sensitive Communication (TSC) scenario. The mMTC scenario, URLLC scenario, and/or TSC scenario may be applied in Internet of Things (IoT) communication. One communication network (e.g., one communication system) may support all of the scenarios described above or some of the scenarios described above. In a communication network supporting the mMTC scenario, IMT-2020 requirements can be satisfied by using narrowband (NB)-IoT and LTE-MTC. A lot of discussion may be needed to satisfy the requirements in a communication system that supports the URLLC scenario.

In order to reduce an error rate of data, a low modulation and coding scheme (MCS) level (or, low MCS index) may be applied. In order not to increase a size of a field indicated by downlink control information (DCI), frequently used MCS(s) may be selected. In order to apply a lower MCS, a repeated transmission operation may be supported. In case of applying a quadrature phase shift keying (QPSK) which is the lowest modulation rate, an effect of further reducing the code rate may occur. In particular, since a transmit power is limited in uplink (UL) transmission, the repeated transmission operation may be performed in the time domain rather than in the frequency domain.

In the case of eMBB traffic and URLLC traffic, a lower MCS may be used for different purposes, respectively. For example, for eMBB traffic, a lower MCS may be required to extend a coverage. On the other hand, for URLLC traffic, a lower MCS may be required to reduce a latency and achieve a lower error rate. Since the requirements are different, the eMBB traffic may be repeatedly transmitted even when a relatively large latency occurs. The URLLC traffic may be transmitted using new MCSs (e.g., low MCS) rather than the repeated transmission. The new MCS may be configured by an RRC message and/or a DCI.

In order to support repeated transmissions for the eMBB traffic in the time domain, a physical uplink shared channel (PUSCH) repetition (e.g., PUSCH repetition type A) may be introduced. In this case, a PUSCH allocated on a slot basis may be repeatedly transmitted. To extend a coverage, a time resource may be allocated over a plurality of slots. When the PUSCH repetition type A is used, the time resource may be configured by an RRC message and/or a DCI. The number of repetitions of the PUSCH may be indicated by the RRC message, and a time resource for transmitting the PUSCH in the first slot may be indicated by the DCI (e.g., in case of type 2 configured grant (CG) or dynamic grant) or the RRC message (e.g., in case of type 1 CG).

In order to support URLLC traffic, it may be preferable for the terminal to perform frequent reception operations in downlink (DL) resources and/or frequent transmission operations in uplink (UL) resources. In a time division duplex (TDD) system, the terminal may operate based on a half-duplex scheme. Accordingly, a time of supporting DL traffic and/or UL traffic may increase according to a slot pattern. On the other hand, in a frequency division duplex (FDD) system, the terminal may utilize DL resources and UL resources at the same time. Accordingly, the above-described problem in the TDD system may not occur in the FDD system. The FDD system may use two or more carriers. When two or more serving cells are configured to the terminal in the TDD system, the terminal may utilize DL resources and UL resources.

In a communication system including at least one carrier to which FDD is applied (hereinafter referred to as ‘FDD carrier’), there may be no problem regarding a delay time of the terminal. In a communication system including only carrier(s) to which TDD is applied (hereinafter, referred to as ‘TDD carrier(s)’), a problem regarding a delay time of the terminal may exist. In order to solve the above-described problem, slots in the TDD carriers may be configured according to different patterns.

Carrier aggregation (CA) may be configured in the terminal, and a PCell and SCell(s) may be activated. Depending on whether a common search space (CSS) set is included, a cell may be classified into a PCell or an SCell. For example, the PCell may include a CSS set, and the SCell may not include a CSS set. In order to reduce a latency in a communication system supporting URLLC traffic, slots having different patterns may be configured and/or indicated to the terminal.

### Chapter 1 PT-RS Transmission Method

### 1.1 PT-RS Generation Method

A phase tracking-reference signal (PT-RS) may be a pilot additionally transmitted to compensate for a phase noise in a communication system operating in a frequency range 2 (FR2). Resource elements (REs) occupied by the PT-RS may be limited to a region of a physical downlink shared channel (PDSCH) and/or physical uplink shared channel (PUSCH). The PT-RS may be distinguished from a tracking reference signal (TRS) that is transmitted regardless of data allocation. A time resource and a frequency resource in which the PT-RS is mapped may be defined in technical specifications. A base station may indicate PT-RS resources to a terminal through RRC signaling.

### 1.1.1 DFT-s-OFDM-Based PT-RS Generation Method

The terminal may perform a sequence mapping procedure before a discrete Fourier transform (DFT) precoding operation. N_{group}^{PT-RS} may mean the number of PT-RS groups. Nₛₐₘₚ^{group} may mean the number of samples that each of the PT-RS groups has. M_{sc}^{PUSCH} may be given in a table below. According to Equation 1 below, m′ may be derived by s′ and k′. Equation 1 may be used to calculate a value mapped at a position m of the PT-RS. m may mean a position to which the PT-RS is mapped. m may have a value determined by k′, m′, and s′. m may be determined by referring to Table 1 below. w(k) may mean an orthogonal sequence.

$$[ Equation 1 ]$$

$${r}_{m} ( {m}^{′} ) = w ( {k}^{′} ) \cdot \frac{exp ( j \frac{π}{2} ( m mod 2 ) )}{\sqrt{2}} \cdot ( \{ 1 - 2 c ( {m}^{′} ) \} + j \cdot \{ 1 - 2 c ( {m}^{′} ) \} ) ,$$

$$where$$

$${m}^{′} = {N}_{samp}^{group} \cdot {s}^{′} + {k}^{′} ,$$

$${s}^{′} = 0 , 1 , 2 , … , {N}_{group}^{PT - RS} - 1 ,$$

$${k}^{′} = 0 , 1 , 2 , … , {N}_{samp}^{group} - 1$$

c(i) may be a pseudo noise (PN) sequence. For initialization of c(i), a symbol index and a slot index may be used. N_{ID} may be a value configured to the terminal by RRC signaling. For example, N_{ID} may be nPUSCH-Identity, which is an identifier used for a PUSCH.

According to a proposed method, N_{ID} may be configured according to a UL channel using the PT-RS. For example, the base station may configure a separate value (e.g., N_{ID}) to the terminal using RRC signaling. The terminal may identify the separate value through RRC signaling.

The PT-RS may be utilized in a PUSCH or PUCCH. The PT-RS utilized in a PUSCH (hereinafter referred to as ‘PUSCH PT-RS’) may not be distinguished from the PT-RS utilized in a PUCCH (hereinafter referred to as ‘PUCCH PT-RS’). The same N_{ID} may be applied to the PUSCH PT-RS and the PUCCH PT-RS. For example, the terminal may reuse nPUSCH-Identity to initialize the PUCCH PT-RS. In this case, the terminal may reuse an implementation scheme (e.g., circuit, memory) for generating the PUSCH PT-RS.

TABLE 1

| | | Index m of PT-RS samples in an OFDM symbol l prior to |
|---|---|---|
| N_{group}^{PT-RS} | Nₛₐₘₚ^{group} | transform precoding |
| 2 | 2 | s · └M_{sc}^{PUSCH}/4┘ + k - 1 where s = 1, 3 and k = 0, 1 |
| 2 | 4 | $s \cdot {M}_{sc}^{PUSCH} + k where \{ \begin{matrix}s = 0 \\ s = 1\end{matrix} \begin{matrix}and & k = 0 , 1 , 2 , 3 \\ and & k = - 4 , - 3 , - 2 , - 1\end{matrix}$ |
| 4 | 2 | └s · M_{sc}^{PUSCH}/8┘ + k - 1 where s = 1, 3, 5, 7 and k = 0, 1 |
| 4 | 4 | $s \cdot {M}_{s c}^{P U S C H} / 4 + n + k where$ $\{ \begin{matrix}s = 0 & and & k = 0 , 1 , 2 , 3 & n = 0 \\ s = 1 , 2 & and & k = - 2 , - 1 , 0 , 1 & n = ⌊ {M}_{sc}^{P U S C H} / 8 ⌋ \\ s = 4 & and & k = - 4 , - 3 , - 2 , - 1 & n = 0\end{matrix}$ |
| 8 | 4 | $⌊ s \cdot {M}_{s c}^{P U S C H} / 8 + ⌋ + n + k where$ $\{ \begin{matrix}s = 0 & and & k = 0 , 1 , 2 , 3 & n = 0 \\ s = 1 , 2 , 3 , 4 , 5 , 6 & and & k = - 2 , - 1 , 0 , 1 & n = ⌊ {M}_{sc}^{P U S C H} / 16 ⌋ \\ s = 8 & and & k = - 4 , - 3 , - 2 , - 1 & n = 0\end{matrix}$ |

Table 1 may be a table for symbol mapping of the PT-RS. Table 2 may indicate a value of w(i).

TABLE 2

| | Nₛₐₘₚ^{group} = 2 | Nₛₐₘₚ^{group} = 4 |
|---|---|---|
| N_{RNTI} mod Nₛₐₘₚ^{group} | [w(0) w(1)] | [w(0) w(1) w(2) w(3)] |
| 0 | [+1 +1] | [+1 +1 +1 +1] |
| 1 | [+1 −1] | [+1 −1 +1 −1] |
| 2 | — | [+1 +1 −1 −1] |
| 3 | — | [+1 −1 −1 +1] |

The terminal may make resources to which the PT-RS is mapped belong to a PUSCH resource. rₘ(m′) may be amplitude-scaled with β′. β′ may be mapped to Nₛₐₘₚ^{group}·N_{group}^{PT-RS} symbols. \tilde{x}⁽⁰⁾(m) may correspond to a symbol l before performing the DFT precoding operation. \tilde{x}⁽⁰⁾(m) may be expressed as a complex number. β′ may be derived from a difference between a modulation order used for the PUSCH and that of π/2-binary phase shift keying (BPSK). A value of β′ may be defined in Table 3 below.

TABLE 3

| Scheduled modulation | PT-RS scaling factor (β′) |
|---|---|
| π/2-BPSK | 1 |
| QPSK | 1 |
| 16QAM | 3/\sqrt{5} |
| 64QAM | 7/\sqrt{21} |
| 256QAM | 15/\sqrt{85} |

A symbol 0 may be referred to as the first symbol to which the PUSCH is allocated. In this case, in order to derive the symbol 1, the terminal may perform the following procedure.

First step: The terminal may initialize i=0 and l_{ref}=0.

Second step: a period of max(l_{ref}+(i−1)·L_{PT-RS}+1, l_{ref}), . . . , l_{ref}+i·L_{PT-RS} may be considered. A certain symbol belonging to the above-mentioned period may overlap with a symbol used as a demodulation (DM)-RS. In this case, the terminal may set i=1, and may determine l_{ref} as the last symbol of the DM-RS. For example, if there is one DM-RS symbol, l_{ref} may be the corresponding DM-RS symbol. If there are two DM-RS symbols, l_{ref} may be the second DM-RS symbol. The terminal may repeat the second step so that a symbol corresponding to l_{ref}+i·L_{PT-RS} is a PUSCH symbol.

Third step: The terminal may add l_{ref}+i·L_{PT-RS} to a time index of the PT-RS.

Fourth Step: The terminal may increase i by 1.

Fifth Step: The terminal may repeat the second step so that the symbol corresponding to l_{ref}+i·L_{PT-RS} is a PUSCH symbol. Here, L_{PT-RS} may be defined as L_{PT-RS} ∈{1,2}. The base station may configure L_{PT-RS} to the terminal using RRC signaling.

The base station may configure sampleDensity to the terminal using RRC signaling. The terminal may identify sampleDensity through RRC signaling. The terminal may know whether a PT-RS is mapped in an allocated bandwidth of a BWP according to Table 4 below. In addition, the terminal may know a pattern of PT-RS groups according to Table 4 below. When the number of allocated PRBs is less than a specific number (e.g., N_{RB0} if N_{RB0}>1) or when the PUSCH is allocated by a temporary cell-radio network temporary identifier (TC-RNTI), the terminal may assume that a PUSCH PT-RS is not generated.

L_{PT-RS}=1 or L_{PT-RS}=2 may be configured to the terminal. If sampleDensity is configured to the terminal and N_{RB,i}=N_{RB,i+1} is established, the terminal may consider that a row of Table 4 corresponding to the above-described configuration is deactivated. Table 4 may indicate a pattern of PT-RS groups and samples according to the allocated bandwidth.

TABLE 4

| | | Number of samples |
|---|---|---|
| Scheduled bandwidth | Number of PT-RS groups | per PT-RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

When the number of PT-RS groups and the number of samples are given as different values according to the allocated bandwidth, operations of the communication system in an unlicensed band may not be efficient. When transform precoding is performed, in order to maintain a single carrier property in a licensed band, a type 1 frequency domain resource allocation (FDRA) in which physical resource blocks (PRBs) are consecutively allocated may be performed. When a type 0 FDRA is performed, PRBs may be allocated non-consecutively, which may mean an increase in peak-to-average power ratio (PAPR). In an unlicensed band, PRBs may be allocated based on an interlace allocated to a PUSCH as well as a bandwidth allocated to the PUSCH according to frequency regulation and power density adjustment. The interlace allocated to the PUSCH or an interlace allocated for the PUSCH may be referred to as a PUSCH interlace. In exemplary embodiments, an interlace may mean a PUSCH interlace.

In this case, since DCI or RRC signaling for scheduling the PUSCH expresses frequency resources based on the interlace, representation of PT-RS mapping according to Table 4 may be incomplete.
Method 1.1-1: The number of PT-RS groups and/or the number of PT-RS samples may be determined using the number of PUSCH interlaces.
Method 1.1-2: The number of PT-RS groups and/or the number of PT-RS samples may be determined using the number of RB sets allocated to the PUSCH.

The number of PT-RS groups may mean the number of groups that the PT-RS has. The number of PT-RS samples may mean the number of samples for each PT-RS group. As the number of PUSCH interlaces increases in the bandwidth of the PUSCH, frequency density may increase. When one PUSCH interlace is allocated and the base station effectively compensates for a phase noise for the PUSCH (e.g., one PUSCH interlace), phase noise for two or more PUSCH interlaces may be expected to be effectively compensated for at the base station.

According to a proposed method, as the number of PUSCH interlaces decreases, the number of PT-RS groups and/or the number of PT-RS samples may increase. When the terminal transmits the PUSCH in a plurality of RB sets (or listen-before-talk (LBT) subbands), the number of PT-RS groups and/or PT-RS samples may increase. A combination of Methods 1.1-3 and 1.1-4 below may be used.
Method 1.1-3: Even when the number of PUSCH interlaces increases while maintaining the same bandwidth, the number of PT-RS groups and/or the number of PT-RS samples may not increase.

For example, if the number of PUSCH interlaces increases, the number of PT-RS groups and/or PT-RS samples may decrease. When the bandwidth is maintained the same (e.g., the pattern of the LBT subbands is the same), the smaller the number of PUSCH interlaces, the greater the effect on phase noise.

Based on Table 5 below, the number of PT-RS groups may be defined as {Nᵢ}, and the number of PT-RS samples (i.e., samples per PT-RS group) may be defined as {Mᵢ}. i may be an integer. Table 5 may indicate the number of PT-RS groups and/or PT-RS samples according to the number of interlaces (e.g., PUSCH interlaces). According to Method 1.1-3, {Nᵢ} and {Mᵢ} may be defined as non-increasing functions. The number of interlaces (e.g., PUSCH interlaces) that are boundaries for {Nᵢ} and {Mᵢ} may be configured to the terminal through RRC signaling. {Nᵢ} and {Mᵢ} may be defined in technical specifications. In this case, separate signaling for configuring {Nᵢ} and {Mᵢ} to the terminal may be unnecessary.

TABLE 5

| Number of scheduled | | Number of samples |
|---|---|---|
| interlaces | Number of PT-RS groups | per PT-RS group |
| N_{RB0} ≤ N_{RB} < N_{RB1} | N₀ | M₀ |
| N_{RB1} ≤ N_{RB} < N_{RB2} | N₁ | M₁ |
| N_{RB2} ≤ N_{RB} < N_{RB3} | N₂ | M₂ |
| . . . | . . . | . . . |

Method 1.1-4: The number of PT-RS groups and/or PT-RS samples may increase in proportion to the number of PUSCH RB sets.

A PUSCH RB set may mean an RB set allocated to a PUSCH or an RB set allocated for a PUSCH. In exemplary embodiments, an RB set may mean a PUSCH RB set. For example, when a PUSCH is transmitted by increasing only the number of LBT subbands regardless of the number of interlaces (e.g., PUSCH interlaces), the bandwidth of the PUSCH may increase. In this case, since phase noise may increase, it may be preferable to increase a density of PT-RS.

Based on Table 6, the number of PT-RS groups may be defined as {Oᵢ}, and the number of PT-RS samples may be defined as {Bᵢ}. i may be an integer. Table 6 may indicate the number of PT-RS groups and/or PT-RS samples according to the number of RB sets (e.g., PUSCH RB sets). According to Method 1.1-4, {Oᵢ} and {Bᵢ} may be defined as non-decreasing functions. The number of RB sets (e.g., PUSCH RB sets) that are boundaries for {Oᵢ} and {Bᵢ} may be configured to the terminal through RRC signaling. {Oᵢ} and {Bᵢ} may be defined in technical specifications. In this case, separate signaling for configuring {Oᵢ} and {Bᵢ} to the terminal may be unnecessary.

TABLE 6

| Number of scheduled | | Number of samples |
|---|---|---|
| RB sets | Number of PT-RS groups | per PT-RS group |
| N_{RB0} ≤ N_{RB} < N_{RB1} | O₀ | B₀ |
| N_{RB1} ≤ N_{RB} < N_{RB2} | O₁ | B₁ |
| N_{RB2} ≤ N_{RB} < N_{RB3} | O₂ | B₂ |
| . . . | . . . | . . . |

When both the number of interlaces and the number of RB sets are changed, the number of PT-RS groups and/or PT-RS samples may be determined based on priorities of the interlaces and the RB sets. For example, the terminal may determine the number of PT-RS groups and/or PT-RS samples by first applying PT-RS mapping according to the number of RB sets. Thereafter, the terminal may determine the number of PT-RS groups and/or PT-RS samples by applying PT-RS mapping according to the number of interlaces. In this case, the method of interpreting Tables 5 and 6 in the technical specifications may be different. The reason is that the number of interlaces derived from Table 6 should be interpreted with respect to a reference number. For example, Table 6 may indicate the number of PT-RS groups and/or PT-RS samples when one interlace is allocated.

### 1.1.2 CP (Cyclic Prefix)-OFDM Based PT-RS Generation Method

The time resources of the PT-RS may have a constant interval from the last symbol to which a DM-RS is mapped. A modulation and coding scheme (MCS) applied to a PUSCH may be indicated by scheduling downlink control information (DCI), activating DCI, or RRC signaling allocating the PUSCH. According to technical specifications, a time interval L_{PT-RS} of the PT-RS may be determined based on the MCS. For example, L_{PT-RS} may be determined based on Table 7 below. Table 7 may indicate a time density of the PT-RS according to the MCS. When an MCS index is low, the PT-RS may not be mapped. After a range of MCS indexes to which the PT-RS is not mapped, L_{PT-RS} may be determined as one of 1, 2, or 4 according to a range of MCS indexes indicated to the terminal by higher layer signaling. As the MCS index is higher, L_{PT-RS} may correspond to a larger value. The reason is that more phase errors occur when the modulation order and the demodulation order are high.

TABLE 7

| Scheduled MCS | Time density (L_{PT-RS}) |
|---|---|
| I_{MCS} < ptrs-MCS₁ | PT-RS is not present |
| ptrs-MCS1 ≤ I_{MCS} < ptrs- | 4 |
| MCS2 | |
| ptrs-MCS2 ≤ I_{MCS} < ptrs- | 2 |
| MCS3 | |
| ptrs-MCS3 ≤ I_{MCS} < ptrs- | 1 |
| MCS4 | |

Meanwhile, the frequency resources of the PT-RS may have regular intervals in PRBs belonging to the PUSCH. According to technical specifications, a frequency interval (e.g., frequency density) of the PT-RS may be defined. The frequency density may be expressed as K_{PT-RS}. Table 8 may indicate a frequency density of the PT-RS according to the bandwidth allocated to the PUSCH. If the bandwidth allocated to the PUSCH is narrow, the PT-RS may not be mapped. K_{PT-RS} may be determined as one of 2 and 4 according to a range of bandwidths indicated to the terminal by higher layer signaling after a range of bandwidths to which the PT-RS is not mapped. As the bandwidth is wider, K_{PT-RS} may correspond to a larger value. In this case, the frequency density may decrease.

TABLE 8

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

The terminal may perform a PDSCH reception operation and/or a PUSCH transmission operation based on CP-OFDM. The terminal may perform uplink communication (e.g., PUSCH and/or PUCCH transmission operation) based on DFT-s-OFDM. When a PUSCH transmission operation based on DFT-s-OFDM is performed, the terminal may map a PT-RS before performing a DFT precoding operation.

The terminal may map a sequence to a subcarrier k of a MIMO layer j according to layer-to-port association information indicated by DCI or RRC signaling. The terminal may reuse a method of generating a PN sequence or a Gold sequence. Here, a method applied to a PUSCH DM-RS may be applied to the PT-RS. When intra-slot frequency hopping for a PUSCH is not performed, a sequence generated at a position of the first symbol of the DM-RS may be applied to the PT-RS. When intra-slot frequency hopping for the PUSCH is performed, a position of the first symbol of the DM-RS may be defined for each hop, and a sequence generated at the position of the first symbol of the DM-RS in each hop may be applied to the PT-RS.

The terminal may apply a transmit precoding matrix indicator (TPMI). The terminal may apply β in consideration of a transmission power. Here, specific values of k and l mapped by the terminal may follow technical specification. The subcarrier k to which the PT-RS is mapped may be associated with the DM-RS, and the sequence may be mapped based on the aforementioned association. The sequence having equal intervals from the first symbol of the DM-RS may be mapped to a symbol l to which the PT-RS is mapped. The REs to which the PT-RS is mapped may be selected from among REs allocated to the PUSCH.

When a type2 FDRA is used, a PUSCH may be allocated on an interlace basis. When the type2 FDRA is used, the use of PT-RS may not be suitable. The reason is that, according to technical specification, subcarriers to which the PT-RS is mapped are given using an arithmetic progression. Since transform precoding is not performed, the PT-RS may be mapped also to PRBs not allocated to the PUSCH.

As a proposed method, the subcarriers to which the PT-RS is mapped may be interpreted only as PRBs belonging to the interlace. When two or more interlaces are allocated, indexes of the PRBs may be interpreted in the order of a common RB (CRB) grid, regardless of the order of the two or more interlaces.
Method 1.1-5: The PRBs to which the PT-RS is mapped may be interpreted using logical indexes of PRBs belonging to the PUSCH interlace.

### 1.2 PT-RS Configuration Application Method

PT-RS configuration information may include a plurality of parameters. The base station may transmit the PT-RS configuration information to the terminal using RRC signaling. The terminal may configure an RRC connection with the base station. The terminal operating in the RRC connected state may receive the PT-RS configuration information from the base station in a DM-RS configuration procedure. That is, the PT-RS may be configured to the terminal.

Even when the PT-RS is configured, the PT-RS may be mapped to scheduled REs if certain conditions are satisfied.

According to technical specifications, the PT-RS may be mapped in a data region when phase noise is extreme. When a modulation order of data is high, a gain due to the PT-RS may be large. The reason is that symbols modulated by a quadrature amplitude modulation (QAM) scheme may have a higher error rate than symbols modulated by a phase shift keying (PSK) scheme. For example, when the data is modulated with π/2-BPSK or QPSK and a code rate thereof is low, signals (e.g., data) may be relatively robust to phase noise. When the data is modulated with 64 QAM or 256 QAM and a code rate thereof is high, signals (e.g., data) may be relatively vulnerable to phase noise.

The phase noise may be divided into a common phase error and a tone-specific interference. If compensation of the common phase error is possible in a receiving node (e.g., base station in uplink communication), the PT-RS may be unnecessary for data allocated in a narrowband.

If the terminal needs to obtain a high transmission rate, a high code rate and a high modulation order may be used, and the data may be scheduled in a wide band. In this case, it may be preferable that the PT-RS is mapped.

Meanwhile, the terminal may transmit one UL channel. Alternatively, the terminal may simultaneously transmit two UL channels according to configuration or scheduling. The UL channels may be transmitted in overlapping some symbol(s).

For example, the base station may configure carrier aggregation for the terminal, and two or more serving cells may be activated. In this case, the terminal may transmit a PUSCH, PUCCH, and/or physical random access channel (PRACH) to each serving cell.

For example, the terminal may have two or more transmission (Tx) panels. In this case, the terminal may transmit a different PUSCH, PUCCH, and/or PRACH using each of the Tx panels.

For example, the base station may configure dual connectivity for the terminal. In this case, the terminal may transmit a PUSCH, PUCCH, and/or PRACH to each of a master cell group (MCG) and a secondary cell group (SCG).

Since the terminal performs simultaneous transmissions in the above-described scenario, a transmission power may vary temporally. For example, the terminal may receive an uplink cancellation indication (ULCI) and may cancel uplink transmission according to the ULCI during transmission of a PUSCH. If transmission of one UL channel (e.g., PUSCH) is canceled during transmission of two UL channels, a phase noise may occur because the transmission power is changed.

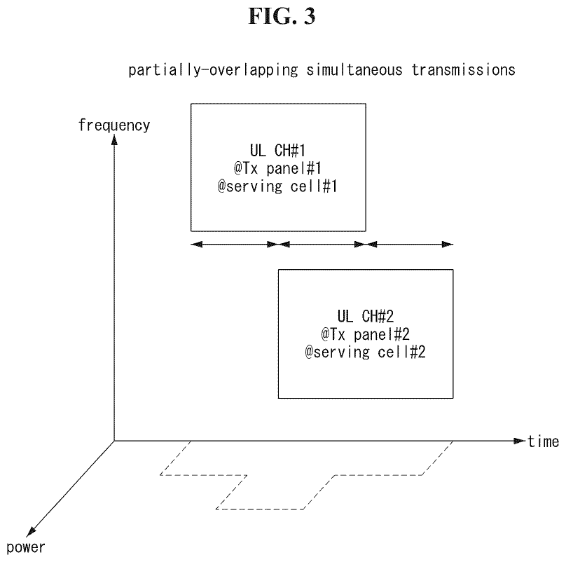

FIG. 3 is a conceptual diagram illustrating a first exemplary embodiment of a change in a transmission power according to simultaneous transmissions of a terminal in time/frequency resources.

Referring to FIG. 3, the transmission power of the terminal may vary in three ways. At a boundary where the transmission power varies, the terminal may not be able to maintain phase continuity between REs through which the UL channel is transmitted.

As a proposed method, a PT-RS may be configured in the FR1 as well as the FR2. That is, a frequency band in which the PT-RS is configured may be extended. In a communication system operating in the FR1, parameters of the PT-RS (e.g., PT-RS configuration information) may be transmitted to the terminal in a DM-RS configuration procedure for UL channel and/or a UL channel configuration procedure.

When the PT-RS is mapped to the FR1 band, enhancement in the frequency domain and time domain may be required. The above-described enhancements may be made in the FR2 as well as in the FR1.

According to RRC signaling and/or technical specifications, the PT-RS may be mapped on a PUSCH or PDSCH. Alternatively, the PT-RS may be omitted from a PUSCH or PDSCH according to RRC signaling and/or technical specifications. According to a proposed method, a specific field of DCI may indicate that the PT-RS is mapped. That is, the DCI may inform the terminal that the PT-RS is mapped.
Method 1.2-1: One value of a specific field of scheduling DCI may mean that a PT-RS is transmitted/received, and another value of the specific field of scheduling DCI may mean that a PT-RS is not mapped.

Although the PT-RS is not mapped according to the conventional technical specifications, it may be advantageous for the PT-RS to be mapped according to a scenario. In order to support this operation, whether the PT-RS is mapped (e.g., whether the PT-RS is transmitted or not) may be dynamically indicated to the terminal. This operation may be applied in a transmission procedure of a PDSCH and/or PUSCH.

### 1.2.1 Enhancement Method in the Frequency Domain

According to a time-domain density L_{PT-RS} of PT-RS mapping, a symbol including the PT-RS may have an interval L_{PT-RS} from the last symbol of the DM-RS. According to configuration or scheduling of the base station, the interval L_{PT-RS} may be smaller than a range in which simultaneous transmissions are possible.

Due to simultaneous transmissions of UL channels or cancellation of UL transmission, a transmission power may be changed. In this case, a phase noise may be preferably estimated based on a previous symbol and a corresponding symbol (e.g., a symbol in which UL channels are simultaneously transmitted or a symbol in which UL transmission is canceled). Accordingly, when the transmission power is changed, the PT-RS may be included in at least one symbol.

For example, that the transmission power is changed when the terminal transmits a PUSCH symbol modulated as a QAM symbol may mean that an amplitude of the QAM symbol is changed. If a PT-RS or DM-RS is included in the QAM symbol, the base station may estimate the amount of amplitude change for the QAM symbol based on the PT-RS or DM-RS. Even when a phase noise needs to be re-estimated, the base station may compensate for the phase noise.

Since the minimum unit that a PUSCH or PUCCH can have is two symbols, the interval L_{PT-RS} may not be a problem in transmission of UL channels having the same subcarrier spacing (SCS). However, the interval L_{PT-RS} may be set too long in transmission of UL channels having different SCSs.

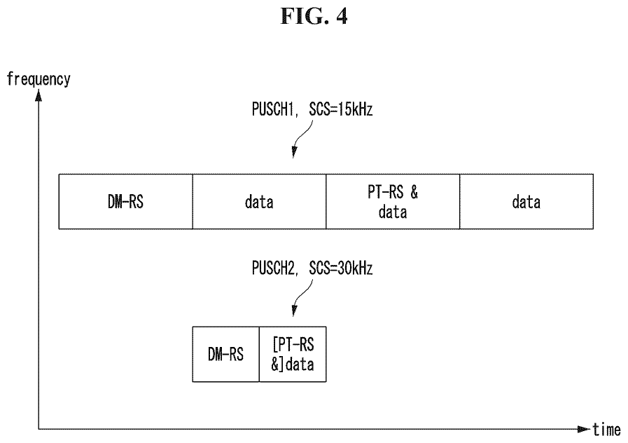

FIG. 4 is a conceptual diagram illustrating a first exemplary embodiment of a method for simultaneous transmission of PUSCHs in two serving cells.

Referring to FIG. 4, when the time density of PT-RS is small in transmission of UL channels having different SCSs, phase continuity may not be maintained. A PUSCH1 may be allocated to four symbols, and a PUSCH2 may be allocated to two symbols. The terminal may simultaneously transmit the PUSCH1 and PUSCH2. A SCS of the PUSCH1 may be different from a SCS of the PUSCH2. When L_{PT-RS} is set to 2, a phase noise may occur from the second symbol of PUSCH1 due to a change in transmission power. The base station performs channel estimation using a DM-RS, but may not be able to compensate for the phase noise. The base station may compensate for a phase noise for the PUSCH2 using channel estimation based on the DM-RS. Therefore, importance of PT-RS in the PUSCH2 may be relatively low.

In order to solve the above-described problem, it may be preferable to map the PT-RS to the first symbol of PUSCH1 overlapping PUSCH2 in the time domain. That is, the base station may schedule the first symbol in which simultaneous transmission of UL channels (i.e., PUSCH1 and PUSCH2) occurs in consideration of the position of PUSCH1. Alternatively, the base station may set L_{PT-RS} for PUSCH1 to 1.

In this case, in order to support simultaneous transmission of UL channels in the FR1, the base station may set L_{PT-RS} of the PT-RS to 1. The terminal may identify the value (i.e., 1) of L_{PT-RS} set by the base station. In this case, significant overhead may occur. That is, the phase noise may be well compensated for by the PT-RS, but the number of REs used for data transmission may be reduced.

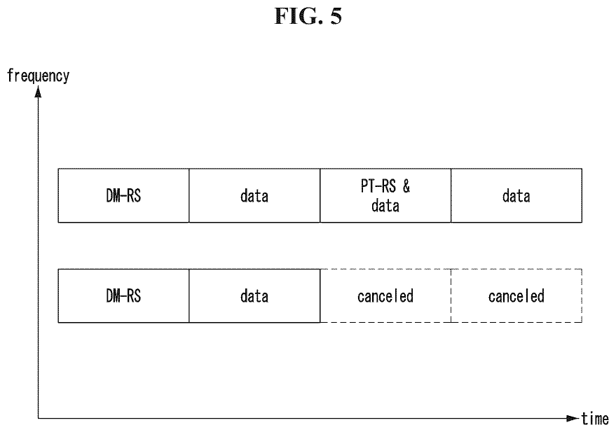

FIG. 5 is a conceptual diagram illustrating a second exemplary embodiment of a method for simultaneous transmission of PUSCHs in two serving cells.

Referring to FIG. 5, the terminal may simultaneously transmit PUSCHs in two serving cells, and one PUSCH (i.e., UL channel) among the PUSCHs may be canceled by ULCI. When the terminal simultaneously transmits the UL channels without ULCI, a transmission power may not be changed. When a reception operation of ULCI is configured to the terminal, the terminal may cancel PUSCH transmission when ULCI is received. The terminal may cancel transmission of a PUSCH even during transmission of the PUSCH. In this case, the transmission power may decrease in the terminal and phase noise may occur. In order to compensate for the phase noise, L_{PT-RS} of the PT-RS may be set to 1. In this case, significant overhead may occur.

In order to solve the above-described problem, a method of reducing a frequency density may be used. This is because the terminal utilizes PT-RS to maintain phase coherence in the FR1, and thus not all wideband PT-RSs applied in the FR2 may be utilized.
Method 1.2-2: The number of PRBs deriving the frequency density of PT-RS may be interpreted differently from the number of scheduled RBs (e.g., PRBs).

For example, the terminal may derive the frequency density of PT-RS using a number smaller than the number of PRBs scheduled for the terminal. The base station may set the minimum number of PRBs for deriving the frequency density of PT-RS to the terminal using RRC signaling. The terminal may identify the minimum number of PRBs set by the base station. Alternatively, the minimum number of PRBs may be determined as one value in technical specifications. For example, a minimum bandwidth value at which PT-RS mapping starts may be reused.

### 1.2.2 Enhancement Method in the Time Domain

According to a time-domain density L_{PT-RS} of PT-RS mapping, a symbol including the PT-RS may have an interval L_{PT-RS} from the last symbol of the DM-RS. In a PUSCH transmission procedure, symbols to which a PUSCH DM-RS is mapped may vary according to a mapping type (e.g., mapping type A or mapping type B). For example, the DM-RS may be mapped to the first symbol of the PUSCH. Alternatively, the PUSCH DM-RS may be mapped to the second symbol or the third symbol (e.g., dmrs-TypeA-Position) of the slot. When the first symbol of the PUSCH is not allocated for the DM-RS, data may be mapped to the first symbol of the PUSCH.

When the PUSCH mapping type B is used, the DM-RS may be mapped from the first symbol (l₀=0) of the PUSCH. When the PUSCH mapping type A is used, the DM-RS may be mapped to the second symbol (l₀=2) or the third symbol (l₀=3) of the slot. When the PUSCH mapping type A is used, the DM-RS may be mapped to the second symbol or the third symbol of the slot in order to align time resources of the DM-RS due to interference from a neighboring cell(s). The base station may set l₀ (e.g., position information of the symbol to which the DM-RS is mapped) to the terminal using RRC signaling. The terminal may identify l₀ set by the base station.

In the conventional technical specifications, a PUSCH PT-RS may be mapped to symbol(s) after the DM-RS symbol. The PUSCH PT-RS may mean a PT-RS used in a PUSCH transmission/reception procedure. The PUSCH DM-RS may mean a DM-RS used in a PUSCH transmission/reception procedure. A DM-RS symbol may mean a symbol to which the DM-RS is mapped. Considering simultaneous transmission of PUSCHs, even when a phase noise occurs in symbol(s) preceding the DM-RS symbol, the base station may perform extrapolation from the first DM-RS symbol.
Method 1.2-3: The PT-RS may be mapped to symbol(s) before the DM-RS symbol.

For Method 1.2-3, a value of L_{PT-RS} may be interpreted as a negative number. For example, if the base station sets L_{PT-RS}=1 or L_{PT-RS}=2 to the terminal, the terminal may interpret it as L_{PT-RS}=−1 or L_{PT-RS}=−2. That is, the value of L_{PT-RS} may be interpreted as an absolute value thereof. In this case, the terminal may map the PT-RS to symbol(s) after the interval L_{PT-RS} from the last DM-RS symbol. In addition, the terminal may map the PT-RS to symbol(s) before the interval L_{PT-RS} from the first DM-RS symbol. In this case, the terminal may map the PT-RS to the first symbol or the second symbol of the slot.
Method 1.2-4: The terminal may map the PT-RS to symbol(s) before the interval L_{PT-RS} from the first DM-RS symbol (e.g., the first PUSCH DM-RS symbol).

### 1.3 Exemplary Embodiments

### 1.3.1 UL Coherence Window

In order to extend a coverage, the terminal may maintain phase continuity or phase coherence by aggregating a plurality of slots or a plurality of instances. The number of aggregated slots or instances may be determined according to capabilities of the terminal. The base station may set or indicate the length of a coherence window to the terminal through RRC signaling in consideration of the capability of the terminal. The terminal may identify the length of the coherence window set or indicated by the base station.

When a transmission power of the terminal is changed, when a Tx beam of the terminal is changed, when a TPMI of the terminal is changed, when a timing advance (TA) of the terminal is changed, or when the terminal performs frequency hopping, phase continuity may not be maintained. That is, a phase noise may occur. Equation 2 below may indicate a relationship between signals (e.g., y[i] and y[j]) transmitted by the terminal.

$$y [ i ] = h \cdot x [ i ] + n [ i ] \qquad [ Equation 2 ]$$

$$y [ j ] = h \cdot x [ i ] \cdot m \cdot {e}^{ϕ \sqrt{- 1}} + n [ j ] = {h}^{′} \cdot x [ i ] + n [ j ] ,$$

$$where$$

$${h}^{′} = h \cdot m \cdot {e}^{ϕ \sqrt{- 1}}$$

The terminal may transmit different PUSCH instances (e.g., PUSCH instance i and PUSCH instance j) on the same radio channel. Due to the transmission of different PUSCH instances, phase noise may occur. The phase noise may be expressed as m·e^{ϕ\sqrt{-1}}.

The base station may not be able to estimate m·e^{ϕ\sqrt{-1}}. Thus, each of h and h′ may be estimated independently. Even when the terminal performs repetitive transmission for coverage extension, the base station may not perform joint channel estimation but may perform soft combining.

However, if consistency for PUSCH instance transmission (or PUCCH instance transmission) is maintained within the coherence window (e.g., m·e^{ϕ\sqrt{-1}}=1), the base station may perform joint channel estimation.

The base station may configure PT-RS resources to the terminal using RRC signaling. The terminal may identify the PT-RS resources configured by the base station. When the PT-RS is used, the size of the coherence window may increase in transmission of a UL occasion. For example, if an RS (e.g., PT-RS, DM-RS) is additionally transmitted at the last boundary of the coherence window that can be maintained by the capability of the terminal, the effect of phase noise in the base station may be minimized.

The density of PT-RS may be smaller than that of DM-RS. In a PUSCH occasion, two PUSCH instances may belong to different coherence windows. In this case, when the PT-RS does not exist, the base station may compensate for a difference (e.g., phase noise) between the coherence windows using only the DM-RS(s). When the PT-RS exists, the base station may estimate phase noise using the PT-RS and the DM-RS.

When the PT-RS is additionally transmitted, a time distance between the RSs (e.g., DM-RS and PT-RS) may be smaller than a time distance between the DM-RSs. Thus, due to the reduced time distance, a gain may occur. Since the PT-RS symbols in the PUSCH instance have the interval of L_{PT-RS}, in the case of using only the DM-RSs, the time distance between the DM-RSs may be at most 14 symbols.
Method 1.3-1: When configuring a coherence window to the terminal, PT-RS configuration information may be included in configuration information of the coherence window. For example, the base station may transmit configuration information of the coherence window including the PT-RS configuration information to the terminal.

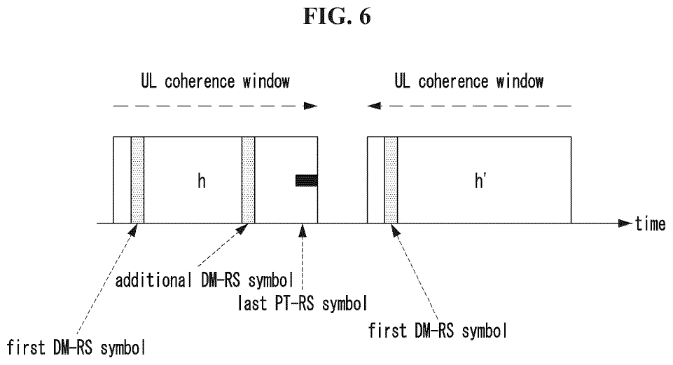

FIG. 6 is a conceptual diagram illustrating a first exemplary embodiment of a method of estimating a phase noise using a PT-RS at a boundary of a UL coherence window.

Referring to FIG. 6, two coherence windows may correspond to a UL occasion of the terminal. In uplink communication, the coherence window may mean a UL coherence window. For example, when a PUSCH repetition type A is configured, the terminal may transmit one PUSCH instance per slot. Therefore, an interval between the first symbol of a PUSCH instance i and the first symbol of a PUSCH instance j may be 14 symbols. Each of i and j may be an integer. When an additional DM-RS is configured, the above-described interval between the symbols may decrease. When the PT-RS is configured, the above-described interval between the symbols may be reduced without additional DM-RS configuration. Since the PT-RS is mapped at an interval of L_{PT-RS}, the PT-RS may be mapped within L_{PT-RS} symbols from the last symbol of the PUSCH instance i. The base station may estimate a phase noise to some extent only with some RSs of the PUSCH instance i and the PUSCH instance j, and may compensate for the estimated phase noise.

### 1.3.2 Initial Access or Broadcasting Information

In an initial access procedure, a PDSCH PT-RS may be considered. The PDSCH PT-RS may mean a PT-RS used in a PDSCH transmission/reception procedure. As a first method, a PDSCH scheduled by DCI having a cyclic redundancy check (CRC) scrambled with a paging (P)-RNTI or a system information (SI)-RNTI may include system information, and a PT-RS (e.g., PDSCH PT-RS) may be mapped. The PDSCH may be dynamically scheduled by the DCI with the P-RNTI or SI-RNTI

A phase noise may not occur due to dynamic factors. That is, a phase noise may occur due to elements by which the communication system operates. Accordingly, only static control or semi-static control may be sufficient for PT-RS transmission (or configuration).

The number of symbols and/or size of a bandwidth in which the PDSCH is scheduled may affect the phase noise. Alternatively, the number of symbols and/or size of the bandwidth in which the PDSCH is scheduled may not affect the phase noise. When a resource (e.g., PDSCH resource) is dynamically scheduled, a case in which the PT-RS is required or a case in which the PT-RS is not require may occur.
Method 1.3-2: Existence of a PT-RS may be derived from DCI scheduling a PDSCH including system information (e.g., remaining minimum system information (RMSI), system information block (SIB) 1, or general SIB) or a paging message. Alternatively, existence of a PT-RS may be indicated from a field of DCI scheduling a PDSCH including system information or a paging message.

In order to consider a method not using DCI for scheduling a SIB or paging information, the terminal may derive whether a PT-RS is mapped from a synchronization signal/physical broadcast channel (SS/PBCH) block. To support this method, a reception method of a master information block (MIB) may need to be changed. Therefore, the method described above may not be preferable.

For example, in order to derive existence of a PT-RS from DCI, the terminal may determine whether a PT-RS is mapped based on a combination of fields of the DCI. For another example, the terminal may determine whether a PT-RS is mapped using scheduling indicated by the DCI. When the number of REs allocated for a PDSCH (or PUSCH) is greater than a reference number, when the number of symbols scheduled for a PDSCH (or PUSCH) is greater than a reference number, when the number of carriers (or interlaces) scheduled for a PDSCH (or PUSCH) is greater than a reference number, and/or when an MCS indicated by the DCI is higher than a reference MCS index, the terminal may determine that a PT-RS is mapped. The base station may configure reference information (e.g., reference number, reference value, reference MCS index) used to determine whether a PT-RS is mapped to the terminal using RRC signaling.
Method 1.3-3: In Method 1.3-2, the terminal may derive existence of a PT-RS using scheduling information and technical specifications.

When a PDSCH PT-RS is mapped, presence or absence of a PT-RS may be interpreted differently depending on a type of SIB or paging. For example, the terminal may assume that there is no PT-RS on a PDSCH including an SIB1. Whether a PT-RS is mapped on a PDSCH including other SIB(s) may be explicitly indicated to the terminal. To support this operation, the SIB1 indicating scheduling information of SIB(s) may further include a bit string (e.g., bitmap), and each bit in the bit string may indicate whether a PT-RS is mapped on a PDSCH including a SIB x.
Method 1.3-4: The terminal may determine whether to transmit a PT-RS differently depending on the type of data (e.g., SIB or paging).

The amount of data may vary depending on the type of SIB. Therefore, the terminal may determine whether a PT-RS exists using the number of scheduled symbols and/or the number of scheduled subcarriers.
Method 1.3-5: In Method 1.3-4, the SIB1 may include a bitmap, and the bitmap may indicate whether a PT-RS is mapped on a PDSCH through which other system information (OSI) is transmitted.

The SIBs may be distinguished from each other, and one SIB may include scheduling information of other SIB(s) (e.g., OSI) (e.g., information of a slot in which other SIB(s) can be received). The SIB1 may include scheduling information of the OSI. Here, a PT-RS may be mapped on a PDSCH through which the OSI is transmitted. Alternatively, a PT-RS may not be mapped on a PDSCH through which the OSI is transmitted. When a bit of a bitmap included in the SIB1 has a first value (e.g., 0), this may mean that a PT-RS is not mapped on a PDSCH through which SI corresponding to the bit is transmitted. When a bit of the bitmap included in the SIB1 has a second value (e.g., 1), this may mean that a PT-RS is mapped on a PDSCH through which SI corresponding to the bit is transmitted.

For example, the length of the bitmap (e.g., bitmap included in the SIB1) may be equal to the number of SIB types. Each bit may explicitly indicate whether a PT-RS exists on a PDSCH to which an SIB is mapped.

For another example, considering a feature in which a combination of a plurality of SIBs is mapped to a PDSCH, the length of the bitmap (e.g., bitmap included in the SIB1) may be determined on a PDSCH basis. Since there are various schemes of combining SIBs, the length of the bitmap may not be fixed to a single value.

The terminal may assume existence of a PT-RS in a specific deployment scenario. Alternatively, whether a PT-RS exists may be indicated by one bit.

In a satellite communication environment, aerial vehicle communication environment, and/or ultra-high frequency communication environment, phase noise may easily occur. In this case, the terminal may expect a PT-RS to be mapped. For example, the terminal may expect that a PT-RS is mapped on a PDSCH including an SIB or paging information.
Method 1.3-6: Depending on a deployment scenario, communication environment, or center frequency of the communication system, the terminal may assume that a PT-RS exists on a PDSCH including an SIB or paging information.

### 1.3.3 Random Access Procedure

The terminal may transmit a Msg3 (e.g., PUSCH) in an RRC idle (IDLE) state or an RRC inactive (INACTIVE) state. In this case, a PUSCH PT-RS may not be mapped in the Msg3. The terminal may transmit a MsgA (e.g., PUSCH) in the RRC inactive state. Configuration information of the MsgA may not include PT-RS configuration information. The Msg3 may mean a Msg3 PUSCH, and the MsgA may mean a MsgA PUSCH.

In an initial access procedure, the terminal may increase a coverage of signals (e.g., Msg1, Msg3, or MsgA) by transmitting a PUSCH PT-RS. The reason is that the base station may correct a phase reference for a long time using the PUSCH PT-RS. The PUSCH may have one antenna port, and the PT-RS and the DM-RS may have the same preprocessing or spatial relation. According to additional configuration of the base station, the terminal may generate the PT-RS and the DM-RS having a quasi-co-location (QCL) relationship and the same antenna port.

The configuration information of the Msg3 may be included in the SIB1. The SIB1 may include information indicating a modulation scheme (e.g., CP-OFDM scheme or DFT-s-OFDM scheme) of the Msg3, and may include configuration information required for the terminal to map the PT-RS. The terminal may map the PT-RS to the Msg3 according to the configuration information of the SIB1, scheduling information of the Msg3, and/or implicitly determined information.

When the random access procedure is not completed, the base station may not know a capability of the terminal because the contention resolution has not yet been completed. Since the base station may not know whether the terminal has a capability to support the PT-RS, it may be preferable that the SIB1 does not include PT-RS configuration information. The terminal operating in the RRC connected state may receive type 2 random access (RA) configuration information from the base station. Since the base station knows the capability of the terminal, the base station may know whether the terminal is able to map the PT-RS in the MsgA. According to a proposed method, the configuration information of MsgA (e.g., MsgA PUSCH configuration information or MsgA PUSCH DM-RS configuration information) may include the PT-RS configuration information. The PT-RS may be mapped on the MsgA PUSCH, and the MsgA PUSCH including the PT-RS may be transmitted.
Method 1.3-8: The PT-RS may be mapped on the Msg3 PUSCH or MsgA PUSCH

According to the above-described method, the base station may reduce influences of phase noise. Therefore, a low error rate may be obtained in one transmission of the MsgA PUSCH.

The terminal may transmit the MsgA PUSCH and may receive a response to the MsgA PUSCH from the base station during a preset period after transmission of the MsgA PUSCH. The terminal may perform a scrambling operation for a DCI format 1_0 using a MsgB-RNTI or C-RNTI. Since the PT-RS is not mapped to a MsgB PDSCH, transmission of the MsgB PDSCH may be vulnerable to phase noise.

According to a proposed method, the base station may map the PT-RS to the MsgB PDSCH. In this case, an error rate for the MsgB PDSCH at the terminal may decrease, and a coverage of the MsgB PDSCH may increase. According to the conventional technique, the PT-RS may not be mapped under a specific condition, and the PT-RS may be mapped under conditions other than specific condition. In a proposed method, even when a modulation order and/or a coding rate of a PDSCH are low, a PT-RS may be mapped on the PDSCH, and DCI may indicate that the PT-RS is mapped on the PDSCH.
Method 1.3-9: Even when an MCS of a PDSCH is low, PT-RS mapping may be allowed on the PDSCH.
Method 1.3-10: A specific field included in DCI for scheduling a PDSCH may indicate to the terminal whether a PT-RS is mapped.

Methods 1.3-9 and 1.3-10 may be applied to a PDSCH scheduled by DCI having a different RNTI (e.g., C-RNTI, MCS-C-RNTI, MsgB-RNTI, etc.).

Since a large number of fields are reserved in a DCI format 1_0 for scheduling a MsgB PDSCH, and some fields of the DCI format 1_0 may be used as information fields.

The PDSCH may be transmitted in the CP-OFDM scheme. When the PDSCH mapping type A is used, the PT-RS may be mapped also to a symbol preceding a DM-RS symbol.

### 1.3.4 PUCCH PT-RS Mapping Method

The above-described PT-RS mapping method may be applied to a PUCCH as well as a PUSCH.

According to conventional technical specifications, symbols to which DM-RSs are allocated in a PUCCH format 3 and PUCCH format 4 may be determined. In a PUCCH resource configuration procedure, whether to perform frequency hopping may be configured. Position(s) of DM-RS when frequency hopping is performed (e.g., position of DM-RS symbol(s)) may be different from position(s) of DM-RS when frequency hopping is not performed. In order to support a terminal moving at a high speed, an additional DM-RS may be configured. Position(s) of DM-RS when the additional DM-RS is configured may be different from position(s) of DM-RS when the additional DM-RS is not configured.
Method 1.3-11: The PT-RS may be configured on a PUCCH.

When a PT-RS is configured on a PUCCH, L_{PT-RS} may be limited to 1 or 2. The reason is that transform precoding is performed for the PUCCH format 3 and the PUCCH format 4, and the position of DM-RS may be maintained the same. However, since the base station estimates a phase noise and performs interpolation on the estimated phase noise, it may be preferable that the base station sets L_{PT-RS} to indicate all symbols. Therefore, Method 1.2-3 and/or Method 1.2-4 may be applied not only to a PUSCH but also to a PUCCH.

Table 9 below may indicate the position(s) of DM-RS in the PUCCH format 3 and PUCCH format 4.

TABLE 9

| DM-RS position l within a PUCCH span | |
|---|---|
| Additional DM-RS | Additional DM-RS |
| does not exist | exists |

| PUCCH | No | | No | |
|---|---|---|---|---|
| length | hopping | Hopping | hopping | Hopping |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

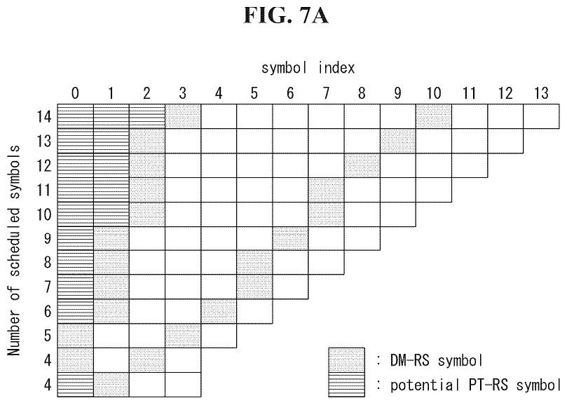

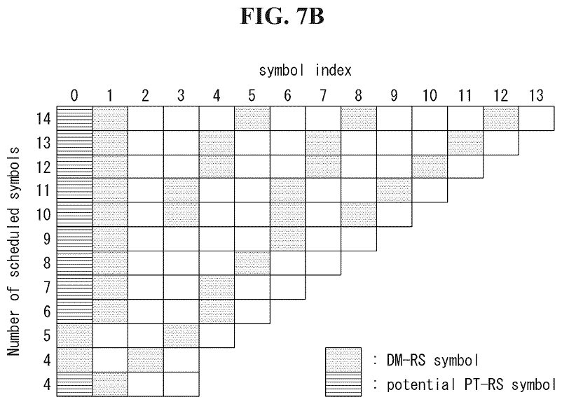

FIG. 7A is a conceptual diagram illustrating a first exemplary embodiment of a method for PUCCH DM-RS and PT-RS configuration, and FIG. 7B is a conceptual diagram illustrating a second exemplary embodiment of a method for PUCCH DM-RS and PT-RS configuration.

Referring to FIGS. 7A and 7B, transform precoding for the PUCCH format 3 and the PUCCH format 4 may be performed. Therefore, in a PT-RS generation/mapping procedure, the PT-RS may be mapped to a symbol at an appropriate position m before the transform precoding is performed. The terminal may interpret a value of L_{PT-RS} as an absolute value, and based on the interpretation result, a symbol to which the PT-RS is mapped before and/or after a PUCCH DM-RS symbol may be derived. The exemplary embodiment of FIG. 7A may represent configuration of a front-loaded DM-RS. The exemplary embodiment of FIG. 7B may represent configuration of a front-loaded DM-RS and an additional DM-RS.

According to the conventional technical specifications, the PT-RS may not be mapped to symbols 0, 1, and/or 2. According to a proposed method, a symbol to which UCI is mapped may be closer to the DM-RS or PT-RS. Therefore, the base station may easily compensate for a phase noise.

### 1.3.5 Transmission Method Using a Multi-Panel

The terminal may have two or more Tx panels. The terminal may transmit UL channel(s) using Tx panels based on various schemes. For example, all Tx panels may have the same antenna port. If the terminal has a plurality of Tx panels, one precoding, Tx beam, or spatial relation information may be applied to the UL channel(s). Therefore, in a beam management procedure, the terminal may assume that one antenna port is simultaneously associated with two or more Tx panels. In this case, the terminal forms a Tx beam, but a radiation pattern may not have one directivity.

For another example, each of the Tx panels may be associated with a different antenna port. One antenna port may have a directional precoding, Tx beam, or spatial relationship information. The Tx beam formed by the terminal may have a clear directivity.

In a PUSCH transmission procedure, scheduling DCI may include association information between the DM-RS and the PT-RS. A field of UL-DCI may include information of 2 bits or more. If the terminal has the capability of full-coherent UL transmission, the PT-RS may have one antenna port. When the terminal has the partial-coherent capability or the non-coherent capability, the PT-RS may have one, two, or four antenna ports. The number of antenna ports of the PUSCH may be eight or less. When a scheduling operation according to a DCI format 0_1 or DCI format 0_2 is performed, a mapping method may be as follows. Here, the number of PT-RS antenna ports and the number of DM-RS antenna ports may be maximum values indicated to the terminal through RRC signaling. The number of DM-RS antenna ports used in an actual PUSCH transmission procedure may be smaller than the maximum value. The transmission of information on the PT-RS antenna ports or the transmission based on the PT-RS antenna ports may not be performed according to specific information (e.g., MCS, RB allocation, etc.).

When there is only one PT-RS antenna port, the PT-RS antenna port may be included in (or associated with) a DM-RS antenna port in a MIMO layer of the PUSCH. This may be one of cases according to the number of DM-RS antenna ports (e.g., 1, 2, 4, or 8). To express this, the size of the DCI field may be 1 bit, 2 bits, or 3 bits.

When there are two PT-RS antenna ports and/or when there are four DM-RS antenna ports, each of the PT-RS antenna ports may be associated with two DM-RS antenna ports. The most significant bit (MSB) in the field of the DCI may indicate that one PT-RS antenna port (e.g., PT-RS antenna port 0) is associated with one of two DM-RS antenna ports (e.g., DM-RS antenna ports 1000 and 1002, or the first DM-RS antenna port and the second DM-RS antenna port corresponding to an SRS resource indicator (SRI)). The least significant bit (LSB) in the field of the DCI may indicate that the other PT-RS antenna port (e.g., PT-RS antenna port 1) is associated with one of the other two DM-RS antenna ports (e.g., DM-RS antenna ports 1001 and 1003, or the first DM-RS antenna port and the second DM-RS antenna port corresponding to a second SRI).

When there are two PT-RS antenna ports and/or when there are eight DM-RS antenna ports, each of the PT-RS antenna ports may be associated with four DM-RS antenna ports. Two bits including the MSB in the field of the DCI may indicate that one PT-RS antenna port (e.g., PT-RS antenna port 0) is associated with one of four DM-RS antenna ports (e.g., DM-RS antenna ports 1000, 1002, 1004, and 1006, or the first, second, third, and fourth DM-RS antenna ports associated with an SRI). Other two bits including the LSB in the field of the DCI may indicate that the other PT-RS antenna port (e.g., PT-RS antenna port 1) is associated with one of the remaining four DM-RS antenna ports (e.g., DM-RS antenna ports 1001, 1003, 1005, and 1007, or the first, second, third, and fourth DM-RS antenna ports associated with a second SRI).

When there are four PT-RS antenna ports and/or when there are four DM-RS antenna ports, separate mapping information for each of the PT-RS antenna ports may be unnecessary. For example, it may be implicitly indicated that a PT-RS antenna port n (n=0, 1, 2, 3) is associated with a DM-RS antenna port 1000+n, or associated with a DM-RS antenna port associated with an SRI, a DM-RS antenna port associated with a second SRI, a DM-RS antenna port associated with a third SRI, and a DM-RS antenna port associated with a fourth SRI. For example, the DCI may not include a separate field for associating the PT-RS antenna port with the DM-RS antenna port. In another example, the DCI may include a field associating the PT-RS antenna port with the DM-RS antenna port. In this case, it may be expected that the value of the field of the DCI is fixed to a certain value. Alternatively, the terminal may expect interpretation specified in the technical specification regardless of the value of the field of the DCI.

When there are four PT-RS antenna ports and/or when there are eight DM-RS antenna ports, each of the PT-RS antenna ports may be associated with two DM-RS antenna ports. For example, a PT-RS antenna port 0 may be associated with DM-RS antenna ports 1000 and 1002, or associated with the first and second DM-RS antenna ports associated with an SRI. Similarly, DM-RS antenna ports associated with each PT-RS antenna port n (n=1, 2, 3) may be derived.

When a PUSCH is scheduled using a different scheme (e.g., DCI format 0_0 or configured grant (CG) scheme), the base station may configure (or indicate) a PT-RS mapping scheme to the terminal using RRC signaling. The PT-RS mapping scheme may be associated with a sounding reference signal (SRS) resource.

When the terminal has two or more Tx panels, two or more antenna ports of a PUCCH DM-RS may be configured to effectively utilize the two or more Tx panels.
Method 1.3-12: Two or more antenna ports for a PUCCH DM-RS may be configured.

In a PUCCH resource configuration procedure, two or more SRS resources, CSI-RS resources, or SS/PBCH blocks associated with DM-RS configuration information and spatial relationship information may be configured. The base station may configure or indicate information capable of deriving two or more antenna ports for a PUCCH DM-RS to the terminal.

When a PT-RS is mapped in transmission of the PUCCH, the PT-RS may be associated with a SRS resource or information derived from a Tx beam of the PUCCH. PT-RS mapping-related information may be indicated by a field included in DL-DCI.
Method 1.3-13: DL-DCI for scheduling a PDSCH may include PT-RS configuration information (e.g., mapping information).

Mapping information of the PT-RS and PUCCH DM-RS may be derived from a field of the DL-DCI. The number of antenna ports of the PUCCH may be one or more. DM-RS antenna ports may be configured as many as the number of Tx panels.

Configuration information of a PUCCH resource may include information indicating the number of DM-RS antenna ports. If two or more DM-RS antenna ports are configured, a field of the DL-DCI may indicate an association between the PUCCH DM-RS antenna port and the PT-RS antenna port to the terminal.

In order to express the association between the PUCCH DM-RS and the PT-RS using the field of the DCI, the DCI may be changed. Thus, the existing DCI may be reused based on a semi-static scheme.
Method 1.3-14: PT-RS information may be derived from information related to spatial relation information (or Tx beam) of the PUCCH.

The information on the PT-RS antenna port may be included in configuration information of the PUCCH resource. Therefore, the terminal may derive an association between the PUCCH DM-RS antenna port and the PT-RS antenna port from a resource index of the PUCCH.

### 1.3.6 Small Data Transmission (SDT) Method

The terminal operating in the RRC inactive state or RRC idle state may perform a procedure for transmitting and receiving data with the base station. To support this operation, scheduling information of a PDSCH or PUSCH may be transmitted to the terminal in advance. The terminal may determine (or identify) the scheduling information by receiving RRC signaling (e.g., dedicated RRC signaling or broadcast RRC signaling) from the base station.

Specific resource(s) may be allocated for emergency communication between the terminal and the base station. In this case, the terminal operating in the RRC inactive state or RRC idle state may transmit and receive small data using the specific resource(s).

To extend the coverage area, a PT-RS may be mapped on a PDSCH or PUSCH. The terminal may determine whether the PT-RS is mapped based on a combination of information indicated by the RRC signaling and the scheduling information. In the case of the PDSCH, the terminal may determine whether a PDSCH PT-RS is mapped using DCI.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a terminal, comprising:
receiving, from a base station, downlink control information (DCI) including information indicating whether a phase tracking-reference signal (PT-RS) is mapped;
identifying that the PT-RS is mapped on a data channel based on the information; and
performing a transmission/reception procedure of the data channel including the PT-RS with the base station.

2. The method according to claim 1, wherein the data channel is a physical downlink shared channel (PDSCH) including system information or a paging message, and the DCI schedules the PDSCH.

3. The method according to claim 1, wherein the data channel is a physical uplink shared channel (PUSCH) transmitted in a random access procedure, and the DCI schedules the PUSCH.

4. The method according to claim 1, further comprising receiving information indicating a mapping interval of the PT-RS from the base station, wherein the PT-RS is mapped in time domain according to the mapping interval indicated by the base station.

5. The method according to claim 4, wherein the PT-RS is mapped according to the mapping interval based on a demodulation (DM)-RS of the data channel.

6. The method according to claim 1, further comprising transmitting uplink control information (UCI) to the base station on a physical uplink control channel (PUCCH), wherein the PT-RS is mapped on the PUCCH.

7. The method according to claim 6, wherein the PT-RS is mapped before a DM-RS symbol on the PUCCH.

8. A method of a base station, comprising:
transmitting, to a terminal, downlink control information (DCI) including information indicating whether a phase tracking-reference signal (PT-RS) is mapped; and
in response to that the PT-RS is indicated to be mapped on a data channel, performing a transmission/reception procedure of the data channel including the PT-RS with the terminal.

9. The method according to claim 8, wherein the data channel is a physical downlink shared channel (PDSCH) including system information or a paging message, and the DCI schedules the PDSCH.

10. The method according to claim 8, wherein the data channel is a physical uplink shared channel (PUSCH) transmitted in a random access procedure, and the DCI schedules the PUSCH.

11. The method according to claim 8, further comprising transmitting information indicating a mapping interval of the PT-RS to the terminal, wherein the PT-RS is mapped in time domain according to the mapping interval.

12. The method according to claim 11, wherein the PT-RS is mapped according to the mapping interval based on a demodulation (DM)-RS of the data channel.

13. The method according to claim 8, further comprising receiving uplink control information (UCI) from the terminal on a physical uplink control channel (PUCCH), wherein the PT-RS is mapped on the PUCCH.

14. The method according to claim 13, wherein the PT-RS is mapped before a DM-RS symbol on the PUCCH.

15. A terminal comprising a processor, wherein the processor causes the terminal to perform:
receiving, from a base station, downlink control information (DCI) including information indicating whether a phase tracking-reference signal (PT-RS) is mapped;
identifying that the PT-RS is mapped on a data channel based on the information; and
performing a transmission/reception procedure of the data channel including the PT-RS with the base station.

16. The terminal according to claim 15, wherein the data channel is a physical downlink shared channel (PDSCH) including system information or a paging message, and the DCI schedules the PDSCH.

17. The terminal according to claim 15, wherein the data channel is a physical uplink shared channel (PUSCH) transmitted in a random access procedure, and the DCI schedules the PUSCH.

18. The terminal according to claim 15, wherein the processor further causes the terminal to perform: receiving information indicating a mapping interval of the PT-RS from the base station, wherein the PT-RS is mapped in time domain according to the mapping interval indicated by the base station.

19. The terminal according to claim 18, wherein the PT-RS is mapped according to the mapping interval based on a demodulation (DM)-RS of the data channel.

20. The terminal according to claim 15, wherein the processor further causes the terminal to perform: transmitting uplink control information (UCI) to the base station on a physical uplink control channel (PUCCH), wherein the PT-RS is mapped before a DM-RS symbol on the PUCCH.
